(19) United States
(12) Patent Application Publication
(10) Pub. No.: US 2014/0368874 A1
(43) Pub. Date: Dec. 18, 2014

(54) COMMUNICATION APPARATUS, COMMUNICATION METHOD AND STORAGE MEDIUM

(71) Applicant: CANON KABUSHIKI KAISHA, Tokyo (JP)

(72) Inventors: Takeshi Suzuki, Inagi-shi (JP); Takashi Moriya, Yokohama-shi (JP); Arata Miyagi, Yokohama-shi (JP)

(21) Appl. No.: 14/302,204

(22) Filed: Jun. 11, 2014

(30) Foreign Application Priority Data
Jun. 14, 2013 (JP) 2013-125884

(51) Int. Cl. H04N 1/00; H04W 48/16; H04N 1/333

(52) U.S. Cl. CPC H04N 1/00217; H04N 1/33346; H04W 48/16; H04N 2201/0094; H04N 2201/0055; H04N 2201/0039; H04W 80/12
USPC 358/1.15

(57) ABSTRACT

According to an aspect of the present invention, a communication resource may be saved for wireless communication in peer-to-peer mode. A communication apparatus acquires information regarding a protocol from another communication apparatus and invalidates protocols not to be used based on the information.

### BACKGROUND

1. Field

Aspects of the present invention generally relate to communication apparatuses, communication methods and programs for wireless connection.

2. Description of the Related Art

Wi-Fi Direct® (hereinafter, called WFD) is one of wireless communication standards. The WFD is a standard that allows data transmission and reception through direct connection between terminals, without requiring a relay access point (AP) used in general Wi-Fi connection systems, among wireless communication standards authorized by Wi-Fi Alliance.

WFD has a protocol specification for automatically determining whether each of electronic apparatuses involved operate as a wireless LAN AP or a wireless LAN station. This specification may eliminate the necessity for a dedicated relay AP as in conventional cases and allows direct connection between electronic apparatuses. Such system for direct connection between terminals in a wireless LAN may also include “ad hoc mode” in addition to WFD. The ad hoc mode is a peer-to-peer (P2P) system for connecting between terminals. WFD and ad hoc mode are different in that WFD is a system in which one terminal implements an AP function in a wireless LAN by software while ad hoc mode does not use an AP.

Japanese Patent Laid-Open No. 2013-42400 discloses a technology utilizing WFD. According to Japanese Patent Laid-Open No. 2013-42400, a PC communicates in a wireless manner with a printer through a WFD function to transmit print data.

It may be convenient to configure such that one communication apparatus may use a Wi-Fi Direct® P2P wireless connection system and a system which performs wireless communication through an AP (such as infrastructure mode) simultaneously. Internet protocol (IP) versions usable for wireless communication may include Version 4 and Version 6. Some communication apparatuses may include a dual stack mode which allows simultaneous use of the two protocol versions. Thus, for operations in a dual stack mode with a P2P wireless connection system and a system which performs wireless communication via an AP, four IP stacks operate. However, the resource of an embedded device such as a resource of a memory may not be sufficient for such simultaneous operations of four IP stacks. An increased number of sockets may also lower the communication speed.

### SUMMARY

Aspects of the present invention generally provide a communication apparatus and a control method and program therefor which may save a communication resource for wireless communication in a peer-to-peer mode.

According to an aspect of the present invention, there is provided a communication apparatus including a communication unit configured to wirelessly communicate with another communication apparatus in a peer-to-peer mode, an acquiring unit configured to acquire information regarding a protocol for communicating with the another communication apparatus, a determining unit configured to determine a protocol for communicating with the another communication apparatus based on the information acquired by the acquiring unit, and a setting unit configured to set to invalidate a protocol excluding the protocol determined by the determining unit.

Further features of the present disclosure will become apparent from the following description of exemplary embodiments with reference to the attached drawings.

### BRIEF DESCRIPTION OF THE DRAWINGS

FIG. 1 illustrates a configuration of an MFP.

FIG. 2 illustrates a configuration of a mobile terminal.

FIG. 3 illustrates a wireless connection sequence of a soft AP mode.

FIG. 4 illustrates a wireless connection sequence of a WFD mode.

FIG. 5 illustrates a wireless connection sequence of a WFD extension mode.

FIG. 6 illustrates detail operations in a wireless connection phase by WFD.

FIG. 7 illustrates a flow of processing by an MFP.

FIG. 8 illustrates detail operations in a wireless connection phase by WFD.

FIG. 9 illustrates a flow of processing by an MFP.

FIG. 10 illustrates detail operations in a wireless connection phase by WFD.

FIG. 11 illustrates a flow of processing by an MFP.

FIG. 12 illustrates a flow of processing by an MFP.

### DESCRIPTION OF THE EMBODIMENTS

Exemplary embodiments of the present disclosure will be described in detail below with reference to drawings. It is not intended that relative positioning of and screens displaying constituent elements are limited by the following embodiments.

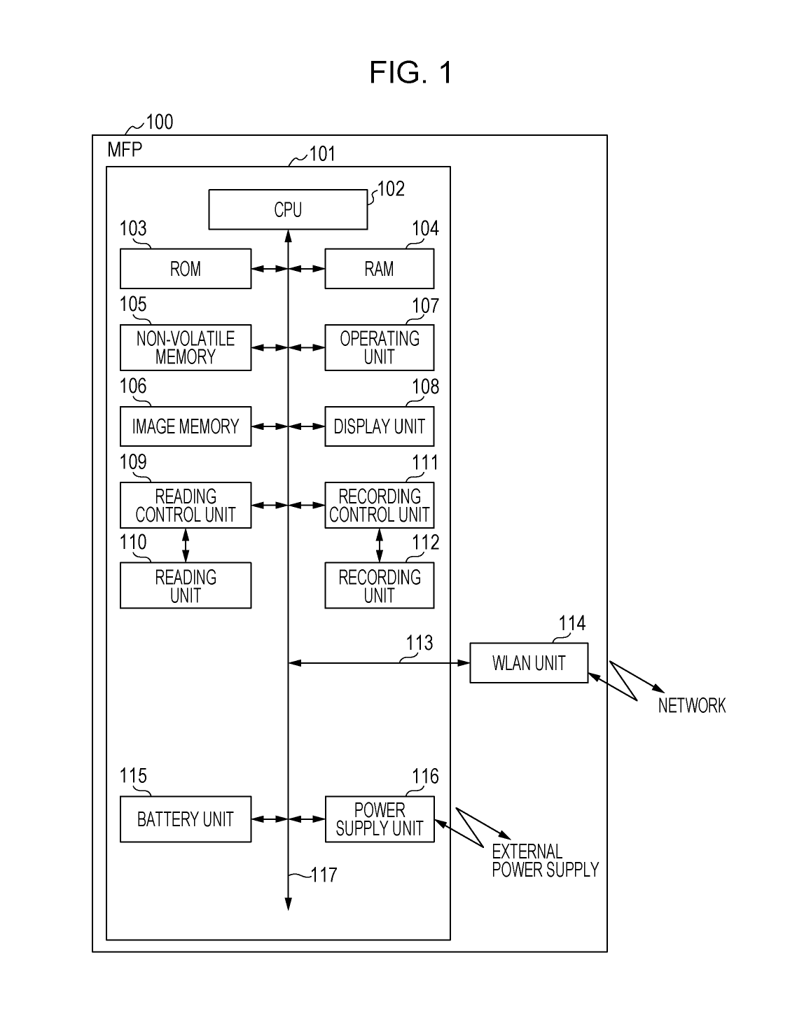

FIG. 1 is a block diagram of a schematic configuration of a multi-function printer (MFP) 100 having a wireless LAN (WLAN) communication function that is an example of an embodiment of a communication apparatus according an exemplary embodiment. The MFP 100 having a reading function and a recording (printing) function will be described as an example. However, additional exemplary embodiments are applicable to one not having one or both of the functions, one having another function, one having a different function from the functions or one having other various functions. Other functions may include a telephone/facsimile function (for a telephone line/IP network), and a short-range wireless communication function (such as Bluetooth® communication and NFC (Near Field Communication)).

The MFP 100 has on a main board 101 a CPU 102, a ROM 103, a RAM 104, a non-volatile memory 105, an image memory 106, an operating unit 107, a display unit 108, a reading control unit 109, a recording control unit 111, a battery unit 115, and a power supply unit 116. The MFP 100 further has a WLAN unit 114 connected thereto via a bus cable 113. These constituent elements are connected via a system bus 117 and are capable of communicating with each other through the system bus 117. The MFP 100 further has a reading unit 110 configured to implement a reading function for reading an image on a document, and a recording unit 112 configured to implement a recording function for recording an image on a recording medium.

The CPU 102 controls the MFP 100 overall. The following processing to be performed by the MFP 100 is executed under control of the CPU 102. The ROM 103 may store control programs to be executed by the CPU 102 and an embedded operating system (OS) program. According to this embodiment, control programs stored in the ROM 103 may perform software control over scheduling and task switching, for example, under control of the embedded OS stored in the ROM 103. The CPU 102 cause a protocol stack (including an IP stack) to operate based on a program stored in the ROM 103 for communication with the other communication apparatus. In this case, a plurality of sockets for communication operations may be set. The RAM 104 stores data such as program control variables and data such as a set value registered by a user and management data for the MFP 100 and has a buffer region for works. The non-volatile memory 105 may be a flash memory and keeps storing data even if powered off. The image memory 106 may be a Dynamic RAM (DRAM) and may store image data input by the reading unit 110 and externally received image data.

The operating unit 107 includes a hard switch and receives an operation from a user and informs a content of the operation to the CPU 102. The display unit 108 implements various types of display regarding the MFP 100 (such as a display for guiding an operation to be performed by a user and a display of information indicative of a state of the MFP 100). A touch panel in which the operating unit 107 and the display unit 108 are provided integrally may be used alternatively.

The reading control unit 109 controls the reading unit (scanner) 110 (such as a contact image sensor (CIS)) to optically read an image on a document and generate image data based on the read image.

The recording control unit 111 converts the input image data to recording data for recording (printing) by the recording unit (printer) 112 and controls the recording unit 112 to record an image by applying a recording agent onto a recording medium such as paper. The recording unit 112 may be an ink jet printer configured to eject ink as a recording agent through a recording head and record an image onto a recording medium.

The WLAN unit 114 communicates with a terminal over a network (supporting TCP/IP-based communication) by wireless communication. It is assumed here, for example, that the WLAN unit 114 is capable of data (packet) communication in a WLAN system based on IEEE802.11 series. Wireless communication applying the WLAN unit 114 is capable of communication based on Wi-Fi Direct® (WFD) and has a software access point (soft AP) function. The WLAN unit 114 is further capable of communication by ad hoc mode and infrastructure mode. The MFP 100 is capable of communication based on both of Internet protocol (IP) version 4 and version 6. The MFP 100 activates IP stacks based on the versions before starting a communication. For communication, a predetermined number of sockets are set to execute a communication process. The MFP 100 is further capable of communication based on a communication protocol selected from a plurality of communication protocols based on a selected IP. Communication protocols selectable here may be protocols of an application layer of an OSI reference model and may include UPnP, Bonjour, WSD, IPP, SMB and so on.

The battery unit 115 is a unit (battery) configured to supply power for the MFP 100 to operate and is capable of supplying power to the MFP 100 even without power supply from an external power source such as a commercially available power source (AC power supply). Therefore, while power is being supplied from the battery unit 115, a user may carry the MFP 100 freely. The battery unit 115 may be internally contained in the MFP 100 or may be detachably attached to the MFP 100. The battery unit 115 may be charged with power from an external power source (such as a commercially available power source), and the MFP 100 may operate without power supply from an external power source while stored electric charges are sufficient for the operation of the MFP 100. The power supply unit 116 receives power from an external power source (commercially available power source (AC power supply)) through a power supply cable and supplies the MFP 100 the power required by the MFP 100 for operating. If the battery unit 115 is mounted in the MFP 100, the power supply unit 116 is capable of supplying power to the battery unit 115 for charging. The power supply unit 116 may include a function for converting AC current from an external power source to DC current.

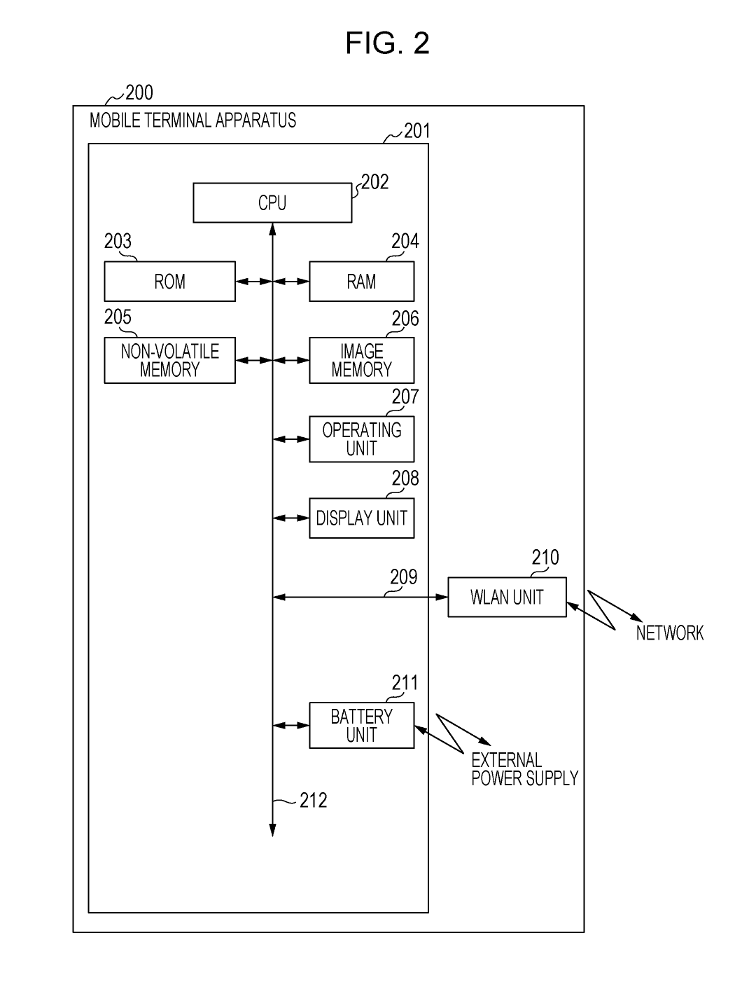

FIG. 2 is a block diagram illustrating a schematic configuration of a mobile terminal 200 that is an example of an embodiment of a communication apparatus. The mobile terminal 200 may be a cellular phone, a smart phone, a laptop PC, a tablet terminal, a Personal Digital Assistant (PDA), a digital camera or other various devices.

The mobile terminal 200 has on a main board 201 a CPU 202, a ROM 203, a RAM 204, a non-volatile memory 205, an image memory 206, an operating unit 207, a display unit 208, and a battery unit 211. The mobile terminal 200 further has a WLAN unit 210 connected thereto via a bus cable 209. These constituent elements are connected via a system bus 212 and are capable of communicating with each other through the system bus system bus 212. Because description on these constituent elements will be similar to the description on the constituent elements illustrated in FIG. 1 having the same names, the description will be omitted.

However, the battery unit 211 in the mobile terminal 200 may be directly charged by an external power source. Therefore, the battery unit 211 not mounted in the mobile terminal 200 is not capable of supplying power to the mobile terminal 200 even if it is connected to an external power source. If the battery unit 211 contains electric charges sufficient for operation of the mobile terminal 200, the mobile terminal 200 may operate without connection to an external power source, which allows a user to carry the mobile terminal 200 freely. The battery unit 211 may be charged by an external power source by supplying power from a commercially available power source (AC power supply) through a charger. The battery unit 211 may be charged by connecting a charger to a commercially available power source and the mobile terminal 200 via a cable or may be charged by wireless power transmission with electromagnetic induction, magnetic resonance, microwaves, direct-current-resonance and so on. A solar photovoltaic which converts received sunlight to power or other systems may be used. The power supply to the mobile terminal 200, without limiting to it, may vary such as one using units equivalent to the battery unit and power supply unit described in FIG. 1.

The non-volatile memory 205 may store various application software programs which may be executed by the CPU 202 to implement various functions. Such application software programs may include a web browser function and an electronic mailing function. FIG. 2 illustrates main constituent elements of the mobile terminal 200. Additionally and/or alternatively, the mobile terminal 200 may include a telephone function, a camera function, a Bluetooth (registered trademark) communication function, an NFC function, a GPS (Global Positioning System) function, a microphone function, a speaker function, a television receiver function and/or other various functions.

### Peer-to-Peer (P2P) System

A plurality of modes may be considered as a system for implementing a peer-to-peer mode (P2P mode) in which apparatuses communicate with each other without through an AP over a WLAN. In both of the modes, a searching apparatus uses a same apparatus search command (such as a Probe Request frame) to search and discover an apparatus to be communicated with (the other communication apparatus). An apparatus search command may be transmitted by attaching various attributes (parameters). It is generally recommended that such an apparatus search command may be responded with an attribute that may be interpreted as much as possible in ranges defined by the specifications of the mode and assumed specifications (such as Wi-Fi for WFD) if the attribute is designated in the search command. Even if information (including the attribute) attached to an apparatus search command includes information that may not be interpreted, the received apparatus search command may be responded based on interpreted information only.

The P2P modes may include the following three modes:

mode A (software AP mode);

mode B (Wi-Fi Direct® (WFD) mode); and

mode C (WFD extension mode)

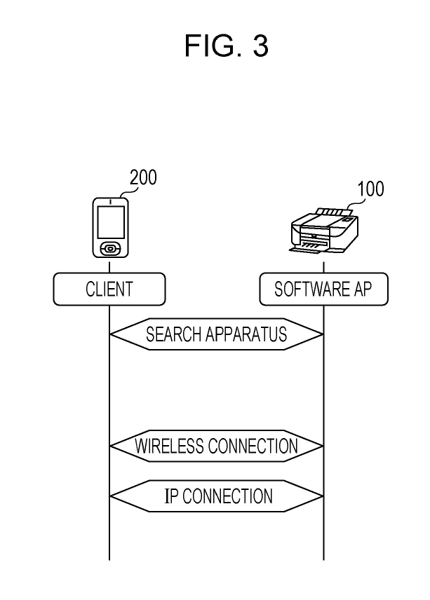

In some cases, these modes may be supported by different apparatuses, and may be usable by different applications. Wireless connection sequences for the modes will be described with reference to FIGS. 3 to 5.

FIG. 3 illustrates a wireless connection sequence for mode A (software AP mode). In software AP mode, one apparatus (such as the mobile terminal 200) of apparatuses in communication (such as the mobile terminal 200 and the MFP 100) plays a role of a client that requests a service. The other apparatus (such as the MFP 100) plays a role of a software AP that implements a function of an access point in a WLAN based on settings by software. In software AP mode, a client searches an apparatus being a software AP by using an apparatus search command. If a software AP is found, the remaining processing for wireless connection (such as establishing a wireless connection) between the client and the software AP is performed, which is followed by processing for IP connection (such as assignment of an IP address). Notably, commands and parameters defined by a Wi-Fi standard may be transmitted and be received for implementation of a wireless connection between a client and a software AP, and the description will be omitted.

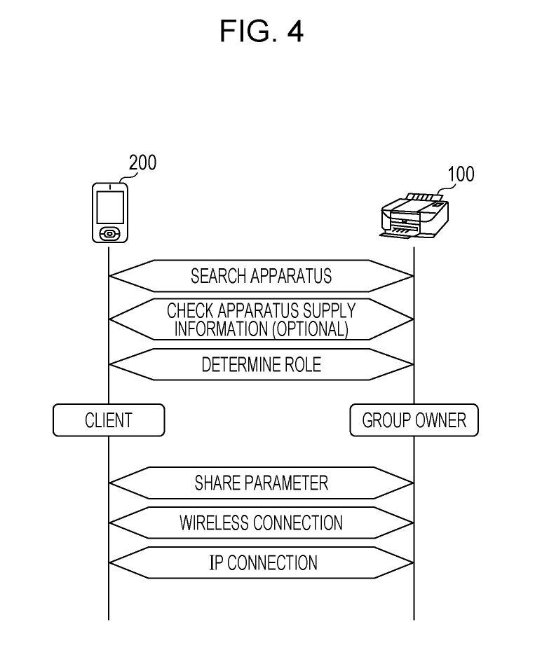

FIG. 4 illustrates a wireless connection sequence for mode B (WFD mode). In WFD mode, an apparatus to be communicated with is searched by transmitting an apparatus search command, and roles of a P2P group owner and a P2P client are then determined to implement a wireless connection. This role determination may correspond to GO Negotiation in P2P, for example. More specifically, one apparatus of apparatuses to communicate with each other issues an apparatus search command to search an apparatus to be connected with in WFD mode. If the other apparatus to be communicated with is discovered, the apparatuses mutually check information regarding services and functions that may be supplied by the apparatuses (apparatus supply information check). The apparatus supply information check is optional and is not required. The apparatus supply information check phase may correspond to Provision Discovery (PD) in P2P, for example. Next, based on the result of the mutual check of the apparatus supply information, which of the apparatuses will play the role of a client in P2P and which of the apparatuses plays the role of a group owner in P2P are determined. It is assumed here, for example, that the mobile terminal 200 plays the role of a client and the MFP 100 plays the role of a group owner. Next, if the client and group owner in P2P are determined, the apparatuses exchange parameters for implementing communication by Wi-Fi Direct® between the apparatuses (parameter exchange phase). Based on the exchanged parameters, the remaining wireless connection processing and IP connection processing are performed between the client and the group owner. The parameter exchange phase may correspond to automatic exchange of wireless LAN security parameters by using Wi-Fi Protected Setup, for example. The apparatus determined as the group owner periodically outputs a beacon signal through a WLAN unit functioning as an AP.

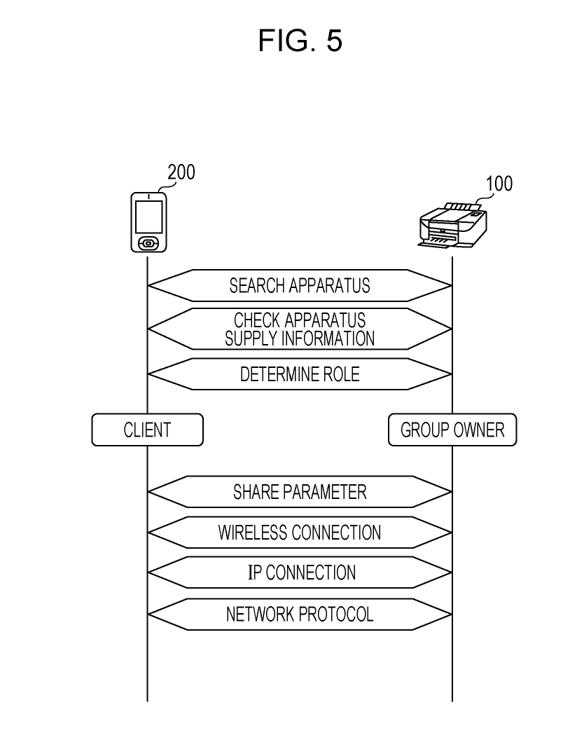

FIG. 5 illustrates a wireless connection sequence in mode C (WFD extension mode). WFD extension mode is an extension of WFD mode and requires apparatus supply information check that is optional in WFD mode. A service to be utilized is provided by using a Service Discovery (SD) command, for example. The other processing is performed similarly to the processing illustrated in FIG. 4. In mode C, the IP connection processing is followed by service connection processing for utilizing a service determined as a result of the exchange above in the extension processing.

Next, processing will be described which adjusts an Owner Intent (group owner intention index) indicative of the strength of intention to be a group owner (service provider) in P2P mode (WFD mode). It is assumed that a default value of Owner Intent may be preset (before a wireless connection) in communication apparatuses. The value may be stored in their non-volatile memories (105, 205) if the communication apparatuses are manufactured or may be set by a user. The Owner Intent may take a value in a range of 0 (Min)-15 (Max), for example. One having a higher value of the communication apparatuses is determined as a group owner through negotiation between them.

Next, processing will be described which adjusts an IP stack of the other communication apparatus in consideration of resource consumption by acquiring information on the IP stack for operations in P2P communication mode.

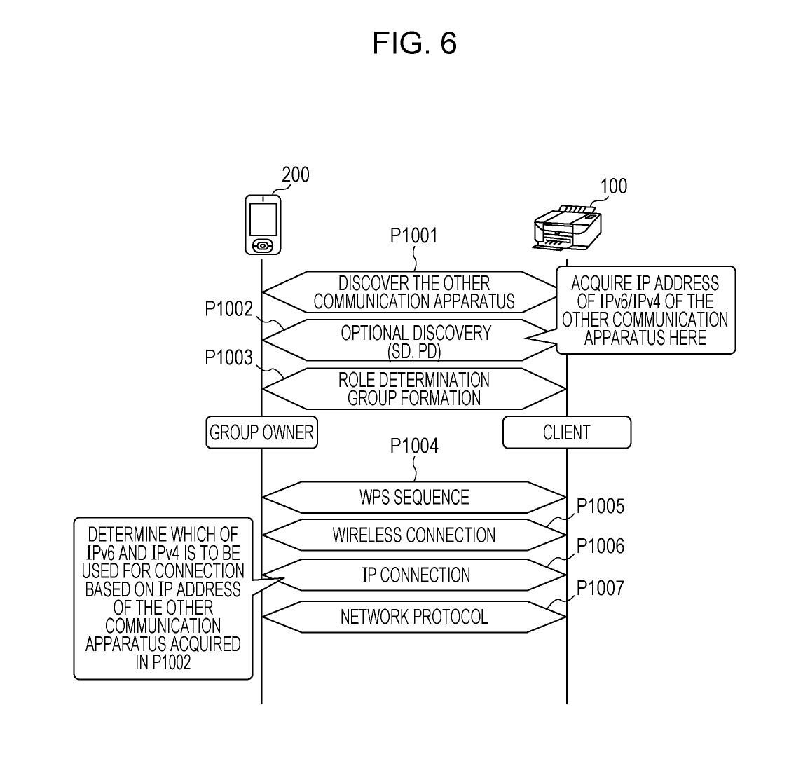

Detail operations of the wireless connection phase in WFD mode (modes B and C) will be described with reference to FIG. 6. The sequence in FIG. 6 is based on the sequences in FIG. 4 and FIG. 5.

P1001: An apparatus search is performed to discover the other communication apparatus. In order to implement this, one communication apparatus (such as the mobile terminal 200) issues an apparatus search request (Discovery) command, and the other communication apparatus (such as the MFP 100) to be communicated with responds to it.

P1002: If the other communication apparatus is settled, the apparatuses to communicate with each other mutually check information regarding services and functions that may be supplied by the apparatuses (apparatus supply information check). This may be implemented by using an Optional Discovery command, an SD command, and a PD command. In this phase, if the other communication apparatus is planned to be a group owner, the other communication apparatus may acquire an IPv4 or IPv6 IP address as information usable by the other communication apparatus for operating as an access point. A 32-bit IP address in IPv4 or a 128-bit IP address in IPv6 is used for communication. On the other hand, if the other communication apparatus does not intend to be a group owner, the acquisition of the IP address of the other communication apparatus is not allowed because the other communication apparatus acquires an IP address later from an access point through DHCP.

P1003: Role determination is performed through Group Owner Negotiation for determining the apparatus which plays the role of a client and the apparatus which plays the role of a group owner (Group Formation). It is assumed here that the MFP 100 that provides a printing service is determined as a client in P2P and the mobile terminal 200 that requests the printing service is determined as a group owner. Group Owner Negotiation which is a process for determining a group owner includes exchange of three (3-way) information pieces of a GO Negotiation Request frame, a GO Negotiation Response frame, and a GO Negotiation Confirmation frame.

P1004: After the client and the group owner are determined, they exchange parameters for establishing communication by Wi-Fi Direct® with each other (WPS sequence).

P1005: The remaining wireless connection processing is performed between the client and the group owner.

P1006: IP connection processing is performed between the client and the group owner. In this phase, whether both of IPv4 and IPv6 are to be used or one of IPv4 and IPv6 is to be used is determined.

P1007: Communication according to a predetermined network protocol is performed between the client and the group owner compliant with the exchanged parameters to exchange print data based on the printing service.

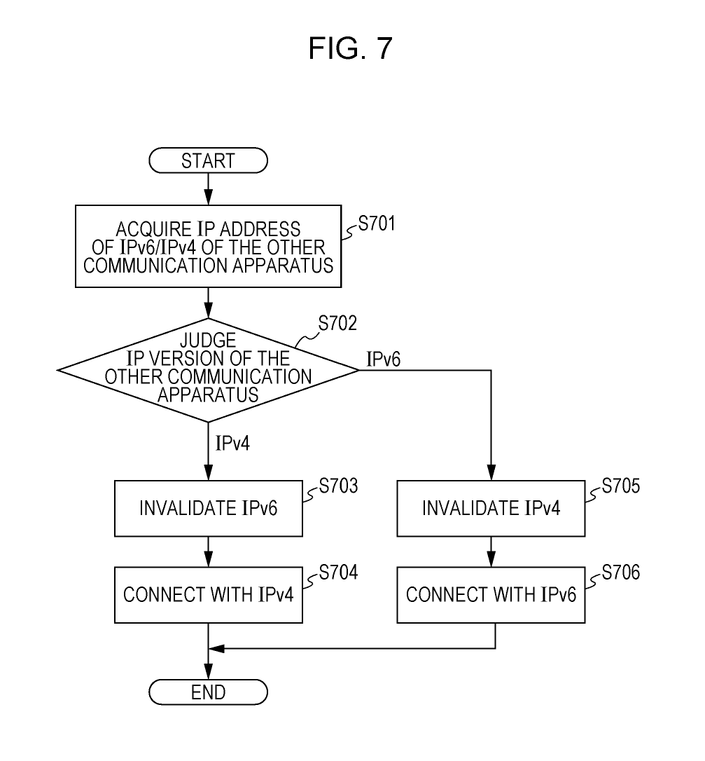

The processing in P1002 to P1006 in FIG. 6 executed by the MFP 100 will be described with reference to FIG. 7. FIG. 7 is a flowchart illustrating a flow of processing executed by loading to the RAM 104 and executing a program stored in the ROM 103 by the CPU 102 in the MFP 100. FIG. 7 illustrates P1002 and P1006 of the processing in FIG. 6, and processing in the other phases is omitted though the processing in the omitted phases is also performed as illustrated in FIG. 6. It is assumed in FIG. 7 that the MFP 100 issues an apparatus search request, and after the other communication apparatus (such as the mobile terminal 200) is discovered (P1001), the MFP 100 checks an IPv4/IPv6 IP address of the other communication apparatus (P1002). Based on the result, the MFP 100 controls the activation of its IP stack. This case will be described, for example. The processing is not limited to the MFP 100 but may be implemented in the mobile terminal 200.

Referring to FIG. 7, in step S701, the MFP 100 acquires an IPv4/IPv6 IP address of the other communication apparatus from the other communication apparatus (mobile terminal 200) in P2P mode discovered in response to the apparatus search request in P1001. In this case, if the other communication apparatus is planned to be a group owner, its IPv4 or IPv6 IP address may be acquired as access point information of the other communication apparatus. Conversely, if the other communication apparatus is planned to be a client, the other communication apparatus will not be an access point. Therefore, the IP address may not be acquired. The determination of the role in P1002 may be checked in the apparatus supply information check.

In step S702, the MFP 100 having performed the phases P1003 to P1005 determines whether the IP address acquired in step S701 is IPv4 or IPv6. If it is IPv4, the processing moves to step S703. If it is IPv6, the processing moves to S705.

In step S703, because the other communication apparatus has an IPv4 address, the communication apparatus invalidates its IP stack for IPv6. In step S704, the IP stack for IPv4 is operated and IPv4 is then used to connect to the other communication apparatus.

On the other hand, in step S705, because the other communication apparatus has an IPv6 address, the communication apparatus invalidates its IP stack for IPv4. Then, in step S706, the IP stack for IPv6 is operated and IPv6 is then used to connect to the other communication apparatus.

Subsequently, communication processing is performed based on the version of the connected IP to execute a printing service, for example. In other words, the MFP 100 uses the recording unit 112 to perform print processing on image data transmitted from the mobile terminal 200 based on the IP address of one of the versions.

The processing in FIGS. 6 and 7 allows adjustment of an IP stack of the communication apparatus based on information on the IP stack in access point information of the other communication apparatus, as described above, which may reduce consumption of a communication resource, for example. In other words, the load on the processing performed by the CPU 102 may be reduced, and the load may further be reduced by reducing the number of sockets for communication through the WLAN unit 114.

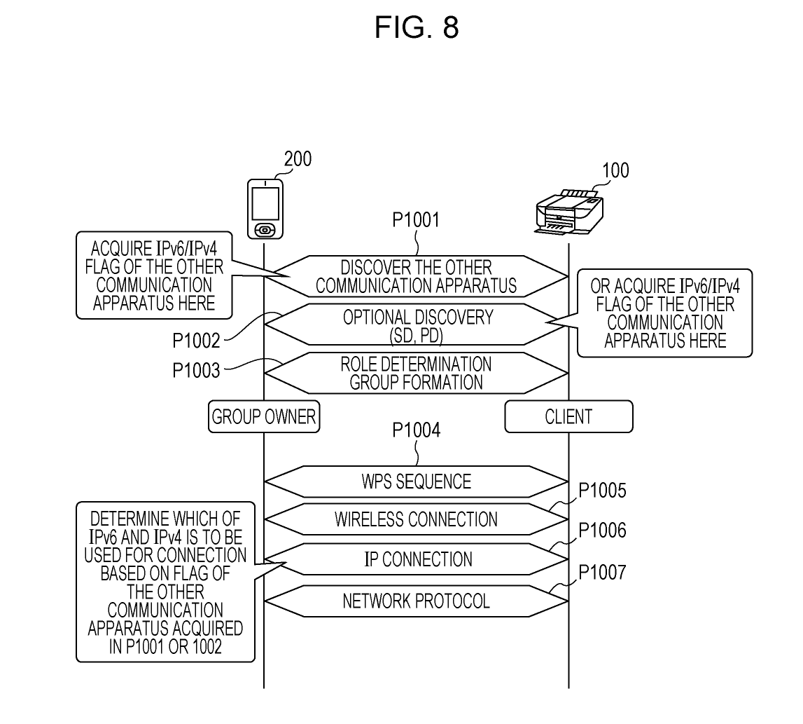

Next, a wireless connection sequence for WFD will be described with reference to FIG. 8. A case will be described in which the other communication apparatus is not planned to be a group owner.

In the example in FIGS. 6 and 7, in a case where the other communication apparatus is planned to be a group owner, the IPv4 or IPv6 IP address may be acquired as access point information of the other communication apparatus. However, in a case where the other communication apparatus is planned to be a client, the MFP 100 functions as an access point, and the other communication apparatus is planned to be assigned an IP address from the access point. Therefore, in P1002, the IPv4 or IPv6 IP address may not be acquired as access point information of the other communication apparatus.

Accordingly, in the example in FIG. 8, in P1001 or P1002, information on an IPv4/IPv6 flag indicating which IP stack is planned to be used by the other communication apparatus is acquired instead of access point information. After that, in P1006, the IP stack to be used is determined based on the acquired information on the IPv4/IPv6 flag.

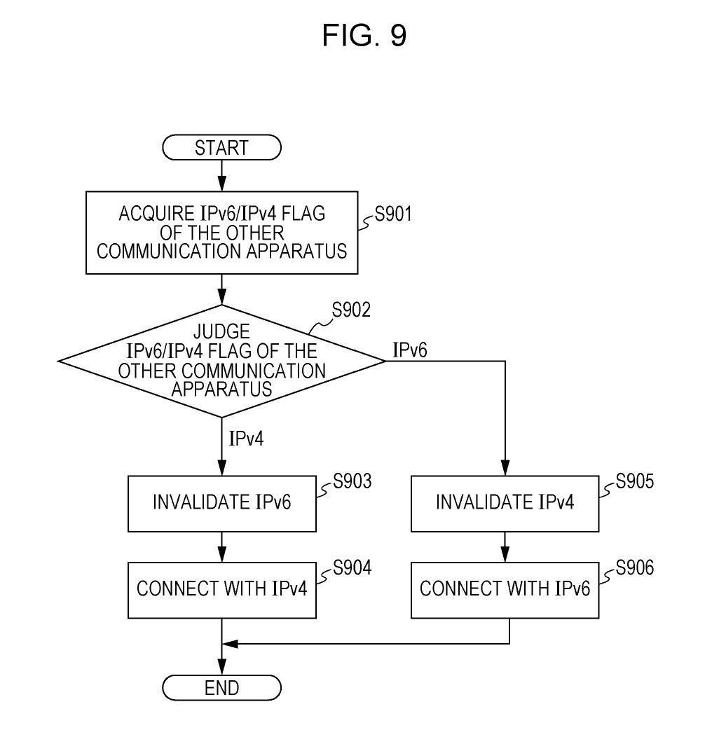

The processing to be executed by the MFP 100 based on the flowchart in FIG. 8 will be described with reference to FIG. 9. FIG. 9 assumes that the MFP 100 issues an apparatus search request to discover the other communication apparatus (such as the mobile terminal 200) (P1001). After that, in P1001 or P1002, IPv4/IPv6 flag information indicative of an IP stack planned to be used is acquired from the other communication apparatus. The processing is not limited to the MFP 100 but may also be implemented in the mobile terminal 200.

FIG. 9 is a flowchart illustrating processing to be executed by the MFP 100. The flowchart in FIG. 9 illustrates a flow of processing to be implemented by loading and executing a program stored in the ROM 103 to the RAM 104 by the CPU 102 in the MFP 100. FIG. 9 illustrates P1001 or P1002 and P1006 of the processing in FIG. 8, and processing in the other phases is omitted though the processing in the omitted phases is also performed as illustrated in FIG. 8.

In step S901, the MFP 100 acquires IPv4/IPv6 flag information indicative of an IP stack planned to be used from the other communication apparatus in P1001 or P1002. In step S902, the MFP 100 determines whether the flag acquired in step S901 indicates IPv4 or IPv6. If it indicates IPv4, the processing moves to step S903. If it indicates IPv6, the processing moves to step S905. Because the processing in step S903 to step S906 is similar to the processing in S703 to S706 described with reference to FIG. 7 above, the description will be omitted.

The processing in FIGS. 8 and 9 allows adjustment of an IP stack of the communication apparatus based on the IPv4/IPv6 flag also in a case where the other communication apparatus is planned to be client, as described above, which may reduce consumption of a communication resource, for example.

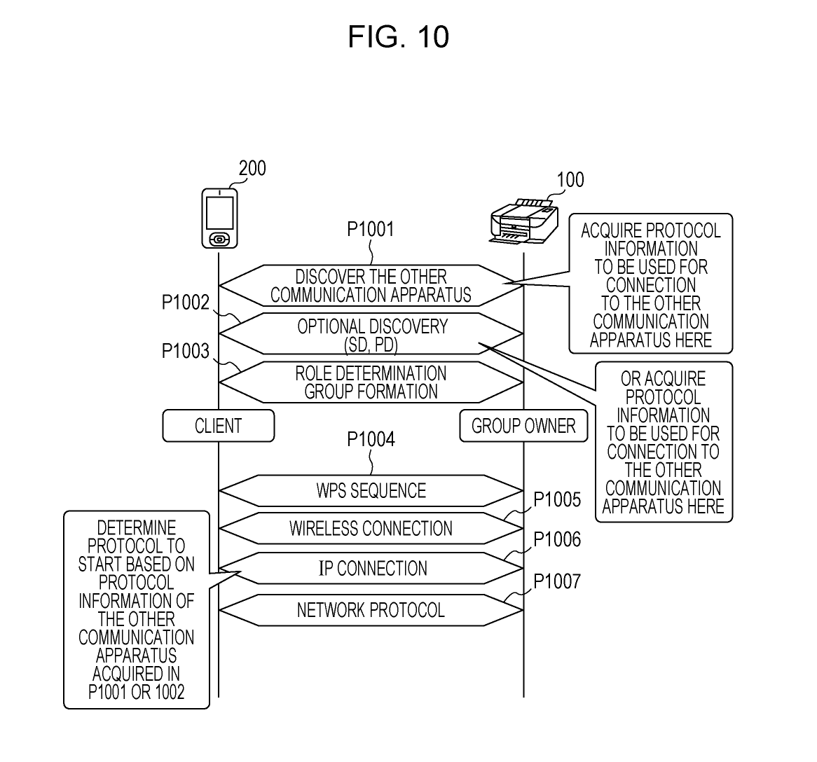

Next, a method for limiting a communication protocol (application layer) in addition to an IP stack in a WFD wireless connection sequence will be described with reference to FIG. 10.

The processing described above may reduce consumption of a communication resource by adjusting an IP stack of the communication apparatus. In a communication apparatus supporting a plurality of communication protocols, one IP stack may operate so that the plurality of communication protocols may use it for communication. In the following example, in P1001 or P1002, communication protocol information to be used by the other communication apparatus is acquired. The communication protocol acquired here may be UPnP, Bonjour, WSD, IPP, SMB, or the like. After that, in P1007, the communication protocol to be used is determined based on the acquired information on the communication protocol to be used (while the protocol stacks of the communication protocol not to be used are invalidated).

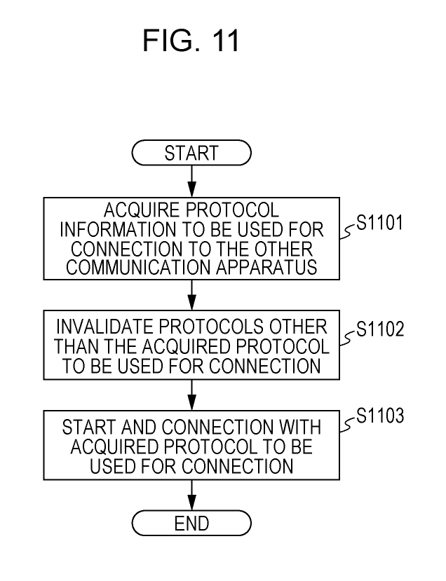

Processing to be executed by the MFP 100 based on the flowchart in FIG. 10 will be described with reference to FIG. 11. FIG. 11 assumes that the MFP 100 issues an apparatus search request to discover an apparatus to be communicated with (which will be called the other communication apparatus, such as the mobile terminal 200) (P1001). After that, in P1001 or P1002, information on the communication protocol to be used is acquired from the other communication apparatus. The processing is not limited to the MFP 100 but may also be implemented in the mobile terminal 200.

FIG. 11 is a flowchart illustrating processing to be executed by the MFP 100. The flowchart in FIG. 11 illustrates a flow of processing to be implemented by loading to the RAM 104 and executing a program stored in the ROM 103 by the CPU 102 in the MFP 100. FIG. 11 illustrates P1001 or 1002 and 1007 of the processing in FIG. 10, and processing in the other phases is omitted though the processing in the omitted phases are also performed as illustrated in FIG. 10.

In step S1101, the MFP 100 acquires information on the communication protocol to be used from the other communication apparatus. In step S1102, the MFP 100 invalidates other protocols than the communication protocol to be used acquired in step S1101. Finally, in step S1103, the acquired communication protocol to be used is used to connect to the other communication apparatus.

The processing in FIGS. 10 and 11 allows adjustment of a communication protocol of the communication apparatus based on the communication protocol to be used by the other communication apparatus, as described above, which may reduce consumption of a communication resource. The information on the communication protocol to be used from the other communication apparatus may be information on all communication protocols to be used by the other communication apparatus or limited information on a communication protocol to be used for the MFP 100. The use of limited information on a communication protocol to be used for the MFP 100 (or invalidating the protocol stacks of the communication protocols not to be used) may further reduce consumption of a communication resource.

Having described above that consumption of a communication resource is reduced by adjusting an IP stack, the processing for reducing consumption of a communication resource is not necessary if the communication resource is sufficient.

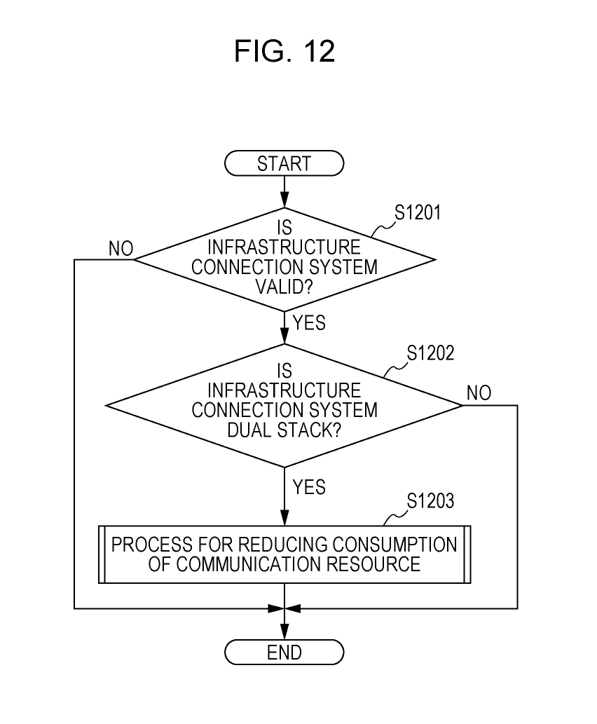

With reference to FIG. 12, a method will be described for determining by the MFP 100 whether the processing for reducing consumption of a communication resource is to be performed or not based on a wireless LAN setting of the MFP 100.

In this case, the MFP 100 supports two wireless LAN connection systems of a P2P wireless connection system and an infrastructure connection system, and whether the systems support (or are permitted to use) both of IPv4 and IPv6 or support only one of them may be set. It is assumed that the MFP 100 supports three IP stacks simultaneously as a communication resource. FIG. 12 assumes that MFP 100 issues an apparatus search request. After the other communication apparatus (such as the mobile terminal 200) is discovered, whether the processing for reducing consumption of the communication resource is to be performed or not is determined. The processing is not limited to the MFP 100 but may also be implemented in the mobile terminal 200. The processing for reducing consumption of a communication resource may be processing for invalidating protocol stacks not to be used as illustrated in FIGS. 7, 9, and 11.

The flowchart in FIG. 12 illustrates a flow of processing to be implemented by loading and executing a program stored in the ROM 103 to the RAM 104 by the CPU 102 in the MFP 100.

In step S1201, the MFP 100 determines whether an infrastructure connection system is set to valid or not in a wireless LAN setting of the MFP 100 based on setting information stored in the non-volatile memory 105. If infrastructure mode is set to valid, it means that wireless communication with a plurality of the other communication apparatuses is allowed by P2P mode and infrastructure mode in parallel. If the infrastructure connection system is set to invalid, use of two IP stacks by the P2P wireless connection system still provides a margin in a communication resource. Therefore, the processing for reducing consumption of the communication resource is not performed. On the other hand, if the infrastructure connection system is set to valid, the processing moves to step S1202.

In step S1202, the MFP 100 determines whether the infrastructure connection system is set to a dual stack mode which supports (or allows to use) both IPv4 and IPv6 or not in the wireless LAN setting of the MFP 100 based on setting information stored in the non-volatile memory 105. If the dual stack mode is set to invalid, the use of two IP stacks by the P2P wireless connection system still provides a margin in the communication resource. Therefore, the processing for reducing consumption of the communication resource is not performed. On the other hand, if the dual stack mode is set to valid, the processing moves to step S1203.

In step S1203, because the infrastructure connection system uses two IP stacks, the processing for reducing consumption of the communication resource described in FIGS. 7, 9, and 11 is performed in the P2P wireless connection system.

The processing in FIG. 12 allows determination of whether the processing for reducing consumption of the communication resource is to be performed or not by the MFP 100 based on the wireless LAN setting for the MFP 100 as described above. If the processing for reducing consumption of the communication resource is not performed, the plurality of protocol stacks are activated. Thus, processing for communication based on the protocols may be quickly started. In the example above, whether the processing for reducing consumption of the communication resource is to be performed or not is determined based on the number of IP stacks supported by the MFP 100. However, the above example is not limited thereto. For example, whether the processing for reducing consumption of the communication resource is to be performed or not may be determined based on the number of communication protocols supported by the MFP 100 and the capacities of the protocol stacks corresponding thereto. In other words, a communication apparatus may determine whether the number of communication protocols permitted to be used by the communication apparatus is higher than a predetermined threshold value or not, and if so, the processing for reducing consumption of the communication resource is performed. Alternatively, a communication apparatus may determine whether the capacity of the protocol stack to be used by the communication apparatus is larger than a predetermined threshold value or not, and if so, the processing for reducing consumption of the communication resource is performed.

According to the above described exemplary embodiment(s), a communication resource may be saved for wireless communication in peer-to-peer mode.

### OTHER EMBODIMENTS

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2013-125884, filed Jun. 14, 2013, which is hereby incorporated by reference herein in its entirety.

What is claimed is:

1. A communication apparatus comprising:
a communication unit configured to wirelessly communicate with another communication apparatus in a peer-to-peer mode;
an acquiring unit configured to acquire information regarding a protocol for communicating with the another communication apparatus;
a determining unit configured to determine a protocol for communicating with the another communication apparatus based on the information acquired by the acquiring unit; and
a setting unit configured to set to invalidate a protocol excluding the protocol determined by the determining unit.

2. The communication apparatus according to claim 1, wherein the acquiring unit acquires information regarding a version of an Internet protocol, and the setting unit invalidates a version excluding the version acquired by the acquiring unit.

3. The communication apparatus according to claim 1, wherein the acquiring unit further acquires information regarding a communication protocol in an application layer, and the setting unit sets to invalidate a communication protocol excluding a communication protocol in the application layer based on information acquired by the acquiring unit.

4. The communication apparatus according to claim 1, wherein the acquiring unit acquires the information based on setting information on an access point for the another communication apparatus.

5. The communication apparatus according to claim 1, wherein the communication unit communicates via wireless communication in an infrastructure mode, and the setting unit sets the invalidating if communication is allowed in both of the peer-to-peer mode and the infrastructure mode in parallel.

6. The communication apparatus according to claim 5, wherein the setting unit sets the invalidating if communication is allowed in both of the peer-to-peer mode and the infrastructure mode in parallel and use of a plurality of versions of Internet protocols in the infrastructure mode is allowed.

7. The communication apparatus according to claim 1, wherein the communication unit performs communication under a protocol based on a protocol stack, and the setting unit invalidates a protocol stack of a protocol not used by the communication unit.

8. The communication apparatus according to claim 7, wherein the setting unit performs the invalidating if the protocol stack has a larger capacity than a predetermined capacity.

9. The communication apparatus according to claim 1, wherein the setting unit performs the invalidating if the number of protocols used by the communication unit is greater than a predetermined number.

10. A control method implemented in a communication apparatus, the control method comprising:
wirelessly communicating with another communication apparatus in a peer-to-peer mode;
acquiring information regarding a protocol for communicating with the another communication apparatus;
determining a protocol for communicating with the another communication apparatus based on the acquired information; and
setting to invalidate a protocol excluding the determined protocol.

11. The control method according to claim 10, wherein acquiring information includes acquiring information regarding a version of an Internet protocol, and setting to invalidate includes invalidating a version excluding the acquired version.

12. The control method according to claim 10, wherein acquiring information further includes acquiring information regarding a communication protocol in an application layer, and
the setting includes setting to invalidate a communication protocol excluding a communication protocol in the application layer based on acquired information.

13. The control method according to claim 10, wherein acquiring information includes acquiring the information based on setting information on an access point for the another communication apparatus.

14. The control method according to claim 10, wherein wireless communication is performed in an infrastructure mode, and setting includes setting the invalidating if communication is allowed in both of the peer-to-peer mode and the infrastructure mode in parallel.

15. The control method according to claim 14, wherein setting includes setting the invalidating if communication is allowed in both of the peer-to-peer mode and the infrastructure mode in parallel and use of a plurality of versions of Internet protocols in the infrastructure mode is allowed.

16. The control method according to claim 10, wherein communication is performed under a protocol based on a protocol stack, and setting includes invalidating a protocol stack of a protocol not used by the communication.

17. The control method according to claim 16, wherein setting includes performing the invalidating protocols if the protocol stack has a larger capacity than a predetermined capacity.

18. The control method according to claim 10, wherein setting includes performing the invalidating protocols excluding the determined protocol if the number of used protocols is greater than a predetermined number.

19. A computer-readable storage medium configured to store computer executable instructions to cause a communication apparatus to execute a method, the method comprising:
wirelessly communicating with another communication apparatus in a peer-to-peer mode;
acquiring information regarding a protocol for communicating with the another communication apparatus;
determining a protocol for communicating with the another communication apparatus based on the acquired information; and
setting to invalidate a protocol excluding the determined protocol.
